(19) United States
(12) Patent Application Publication
(10) Pub. No.: US 2015/0145359 A1
(43) Pub. Date: May 28, 2015

(54) Connector For Motor and Connector Assembly For Motor

(71) Applicant: Tyco Electronics Japan G. K., Kanagawa (JP)

(72) Inventors: Yuya Okada, Kanagaw (JP); Shinji Yamada, Kanagawa (JP)

(73) Assignee: Tyco Electronics Japan G. K., Kanagawa (JP)

(21) Appl. No.: 14/554,528

(22) Filed: Nov. 26, 2014

(30) Foreign Application Priority Data
Nov. 27, 2013 (JP) 2013-245317

(51) Int. Cl. H02K 5/22; H02K 5/10

(52) U.S. Cl. CPC H02K 5/225; H02K 5/10
USPC 310/71

(57) ABSTRACT

A electrical connector for a motor is disclosed having a connector receiving member, a first connector, and a seal assembly. The connector receiving member is disposed on an outer peripheral portion of a stator supporting frame, the stator supporting frame being connected to a stator or a motor housing. The first connector has a first mating portion that mates with the connector receiving member. The seal assembly is positioned in a space between the motor housing and the first mating portion.

### CROSS-REFERENCE TO RELATED APPLICATION

This application claims priority under 35 U.S.C. §119(a)-(d) to Japanese Patent Application No. 2013-245317, dated Nov. 27, 2013.

### FIELD OF THE INVENTION

The invention is generally related to an electrical connector, and more specifically, a motor-mounted electrical connector assembly for an electric motor.

### BACKGROUND

Multi-position connectors are known for use in compact motors such as hybrid type stepping motor of two or more phases, such as the conventional multi-position connector shown in Japanese Patent No. 2001-145325A (hereinafter referred to as “‘325’”).

The conventional multi-position connector of '325 includes a conductor portion having winding holding portions for directly connecting to end portions of respective excitation windings within the motor, and a connecting portion for establishing an electric connection when mated with a complimentary mating connector, such as an integral contact. The conventional multi-position connector is positioned on an insulator of the motor. According to this multi-position connector, connection of the respective end portions of a plurality of excitation windings with cables from an external power supply, can be easily performed without using additional components, such as other relay parts.

Japanese Patent No. 2005-333748A (hereinafter referred to as “'748”) shows a conventional sealing grommet for compact motors. A connector mating portion of the motor is formed from a motor yoke, and an end housing assembled on the motor. A conventional motor-mounted connector, such as the one discussed above in '325, is connected to a connector mating portion of the motor, and mates with a complementary mating connector to form an external connection. The sealing grommet has a lip portion that abuts a joint between the motor yoke or the end housing and the mounted connector. The sealing grommet and the conventional mounted connector are connected to a grommet receiving portion of the mating connector to form an external connection. Upon attachment, the lip portion of the sealing grommet abuts the joint to provide a seal at the connector mating portion.

While the combination of the conventional multi-position connector in '325 and the conventional seal in '748 provide a seal, the combination presents several disadvantages.

For example, when the conventional the multi-position connector is mounted to an insulator of the motor through the use of the conventional seal, a space is formed between a motor housing and the multi-position connector, which often results in poor sealing properties. This is well known in the art, and conventional remedies often include the addition of a filler resin positioned in the space between the housing and the multi-position connector. However, the resin is often unreliable as a sealing material; as minute gaps are commonly generated between the different members, due to differences in linear expansion coefficients of members.

Additionally, when the sealing grommet abuts the joint between the motor yoke or the end housing and the conventional motor-mounted connector, it is impossible to seal the joint until the complementary mating connector is mated with the mounted connector. Therefore, prior to mating the mounted connector with the mating connector, a seal cannot be established between the connector mating portion the motor housing and the motor-mounted connector, through the installation of the motor alone.

Accordingly, there is a need for a motor-mounted connector and a connector assembly for a motor where a reliable seal can be established in the space between the motor housing and the motor-mounted connector, through the installation of the motor alone.

### SUMMARY

A electrical connector for a motor is disclosed having a connector receiving member, a first connector, and a seal assembly. The connector receiving member is disposed on an outer peripheral portion of a stator supporting frame, the stator supporting frame being connected to a stator or a motor housing. The first connector has a first mating portion that mates with the connector receiving member. The seal assembly is positioned in a space between the motor housing and the first mating portion.

### BRIEF DESCRIPTION OF DRAWINGS

The invention will now be described by way of example, with reference to the accompanying Figures, of which:

FIG. 1 is a perspective view of the motor having a motor-mounted electrical connector;

FIG. 2 is a perspective view of stator supporting frame having a connector receiving member connected to a first connector;

FIG. 3 is a perspective view the first connector detached from the connector receiving member;

FIG. 4 is a perspective view of the first connector mated with the connector receiving member, each having a locking mechanism;

FIG. 5 is an enlarged view of the locking mechanism;

FIG. 6 is a partial sectional view of the first connector mated to the connector receiving member;

FIG. 7 is a front perspective view of the stator supporting frame;

FIG. 8 is a side view of the stator supporting frame;

FIG. 9 is a sectional view of the stator supporting frame, taken along line 9-9 in FIG. 8;

FIG. 10 is a perspective view of a motor assembly showing a method of mounting the stator supporting frame to the stator and crimping wire connecting portions to end portions of stator windings;

FIG. 11 is an enlarged view of a wire connecting portion;

FIG. 12 is a perspective view of the motor assembly without the motor housing, after the wire connecting portions have been crimped to the end portions of the stator winding;

FIG. 13 is a perspective view of the electrical connector prior to connecting with the first connector to the connector receiving member;

FIG. 14 is a perspective view the electrical connector being connected to a complementary mating connector.

### DETAILED DESCRIPTION OF THE EMBODIMENT(S)

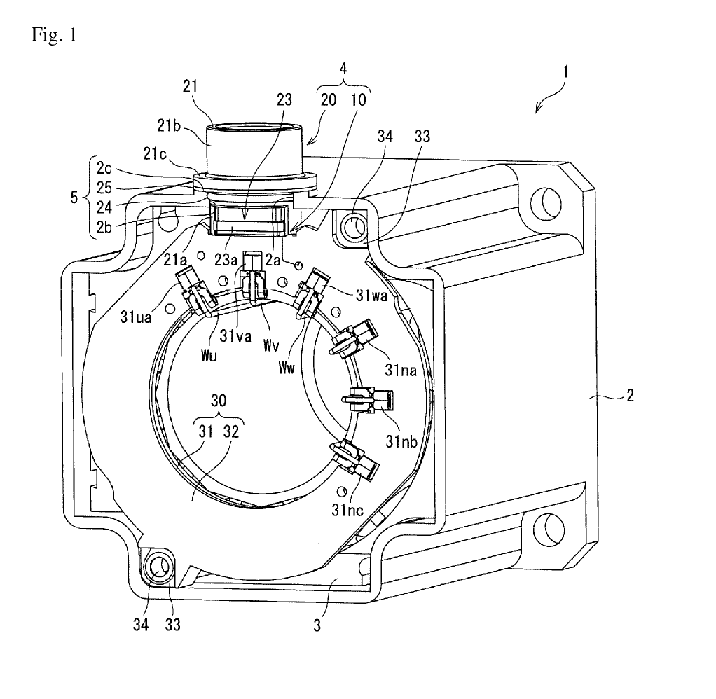

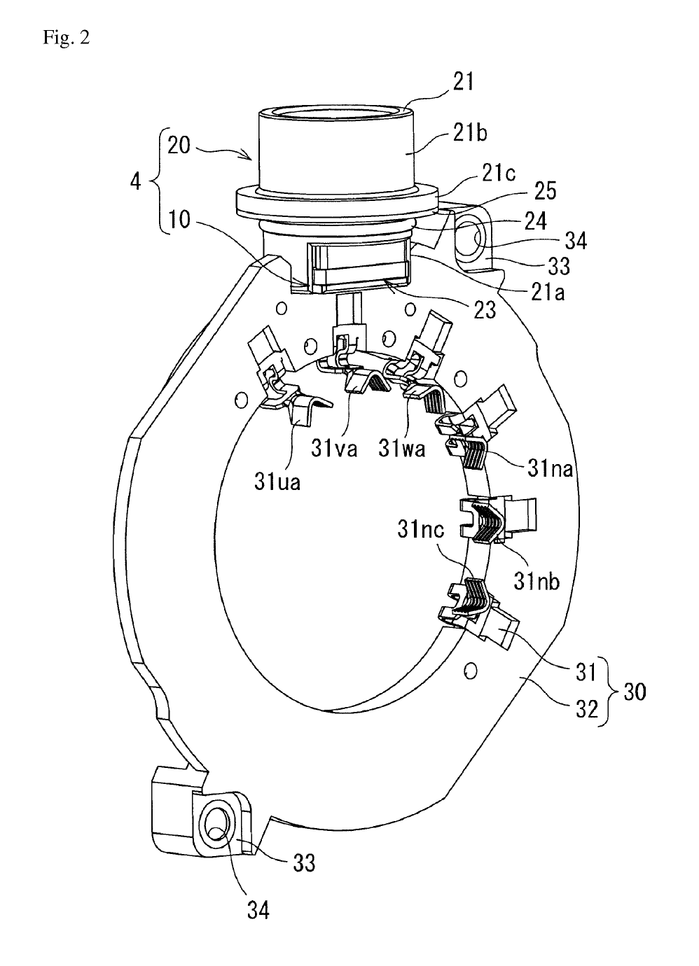

The invention will now be discussed with reference to FIGS. 1-14.

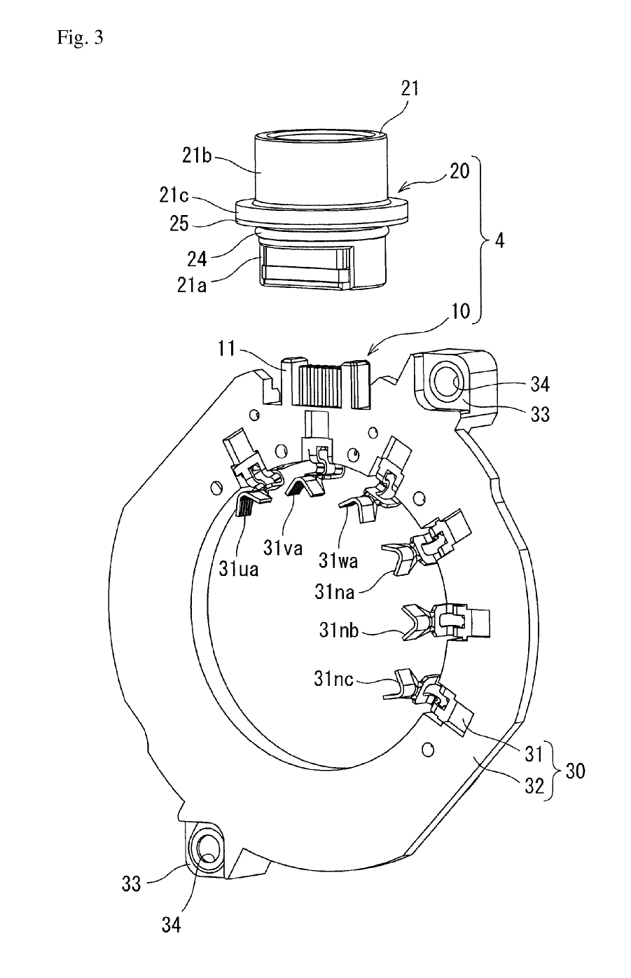

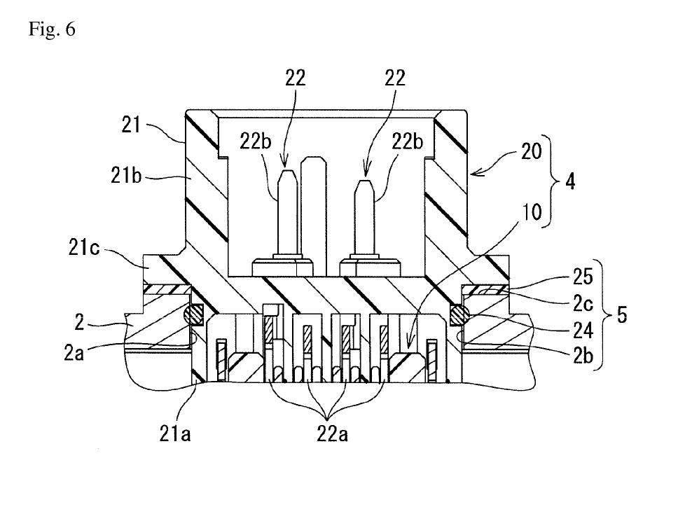

In the embodiment of FIG. 1, a motor 1 includes an electrical connector 4. The motor 1 is a three-phase motor and comprises a stator 3, a rotor (not shown), and stator windings including a U-phase winding Wu, a V-phase winding Wv and a W-phase winding Ww. The stator 3, the rotor and the stator windings Wu,Wv,Ww are positioned in a motor housing 2. A substantially annular stator supporting frame 30 is connected to an end surface of the stator 3, and a connector receiving member 10 is provided on an outer periphery of the stator supporting frame 30 (see FIG. 3). The connector receiving member 10 is positioned within the motor housing 2, as shown in the embodiment of FIG. 6. Further, in the embodiments of FIGS. 1-6, a motor-mounted first connector 20 is positioned to mate with the connector receiving member 10, with the connector receiving member 10 and the connector 20 constitute the electrical connector 4.

The stator supporting frame 30 comprises a conductor plate 31 and an insulating stator housing 32, as shown in the embodiments of FIGS. 1 and 7-9.

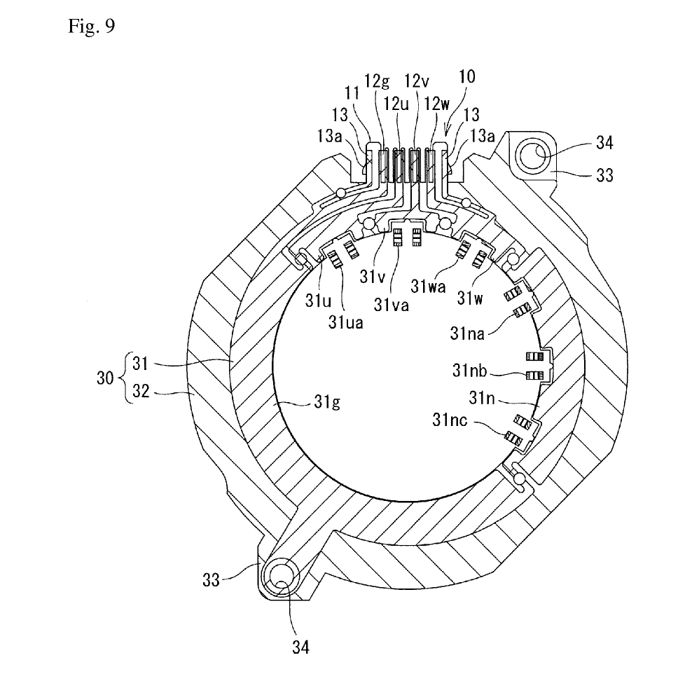

In an embodiment of FIG. 9, the conductor plate 31 has a grounding plate portion 31g, a U-phase portion 31u, a V-phase portion 31v, a W-phase portion 31w and a neutral grounding portion 31n. The conductor plate 31 is shaped to be substantially annular by stamping and forming a conductive metallic plate. The grounding plate portion 31g, the U-phase portion 31u, the V-phase portion 31v, the W-phase portion 31w and the neutral grounding portion 31n are insulated with respect to each other.

A first wire connecting portion 31ua is connected to a first end of the U-phase winding Wu, which is positioned at an inner peripheral portion of the U-phase portion 31u. A second wire connecting portion 31va is connected to a first end of the V-phase winding Wv, which is positioned at an inner peripheral portion of the V-phase portion 31v. A third wire connecting portion 31wa is connected to first end of the W-phase winding Ww, which is positioned at an inner peripheral portion of the W-phase portion 31w. A fourth wire connecting portion 31na is connected to a second end of the U-phase winding Wu, which is positioned at an inner peripheral portion of the neutral point grounding plate portion 31n. A fifth wire connecting portion 31nb is connected to second end of the V-phase winding Wv, which is positioned at an inner peripheral portion of the neutral point grounding plate portion 31n. A sixth wire connecting portion 31nc is connected to a second end of the W-phase winding Ww, which is positioned at an inner peripheral portion of the neutral point grounding plate portion 31n. In an embodiment, the wire connecting portions 31ua, 31va, 31wa, 31na, 31nb and 31nc are crimp contacts that each project from an inner peripheral surface of the conductor plate 31.

In the embodiments of FIGS. 1-4 and 7-9, the insulating stator frame housing 32 is formed to be substantially annular to cover the conductor plate 31 excepting the wire connecting portions 31ua, 31va, 31wa, 31na, 31nb and 31nc. The conductor plate 31 is covered by the stator frame housing 32 through insert molding. Opposing portions on an outer periphery of the stator frame housing 32 are provided with a pair of mounting portions 33 for connecting the stator frame housing 32 to an end surface of the stator 3. Each mounting portion 33 is formed with a fastener receiving through hole 34, through which a mounting screw (not shown) is inserted.

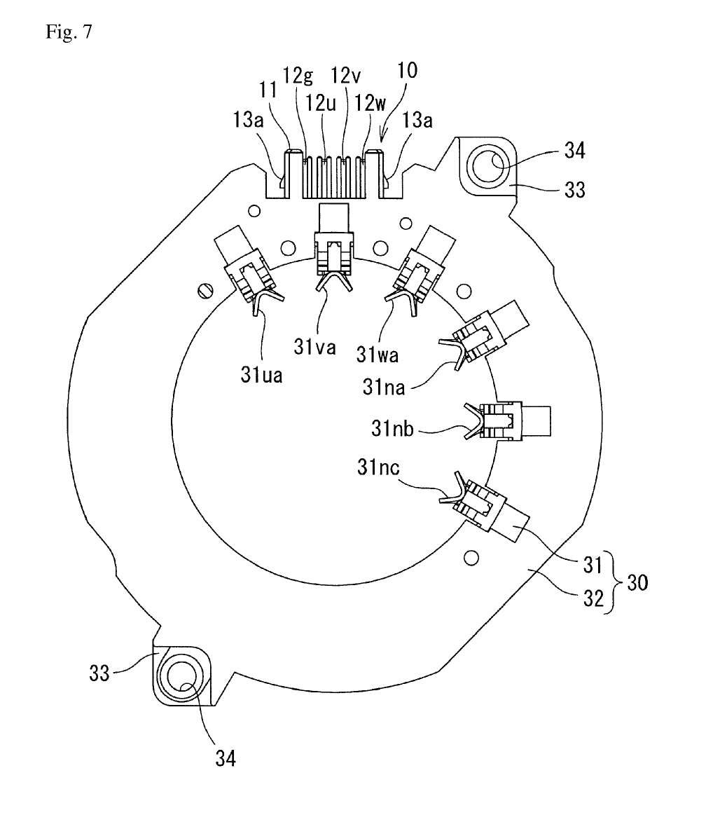

In the embodiments of FIGS. 7-9, the connector receiving member 10 is disposed on the outer peripheral portion of the stator supporting frame 30, and, as shown in the embodiments of FIGS. 3-6, the connector 20 is mated with an outward facing side of the connector receiving member 10. The connector receiving member 10 comprises an insulating connector mount housing 11, a grounding contact 12g, a U-phase contact 12u, a V-phase contact 12v, and a W-phase contact 12w, each contact 12g,12u,12v,12w being mounted at a predetermined pitch along a width direction of the connector mount housing 11. As shown in FIG. 9, the grounding contact 12g extends from the grounding plate portion 31g of the conductor plate 31. The U-phase contact 12u extends from the U-phase portion 31u of the conductor plate 31. The V-phase contact 12v extends from the V-phase portion 31v of the conductor plate 31. The W-phase contact 12w extends from the W-phase portion 31w of the conductor plate 31.

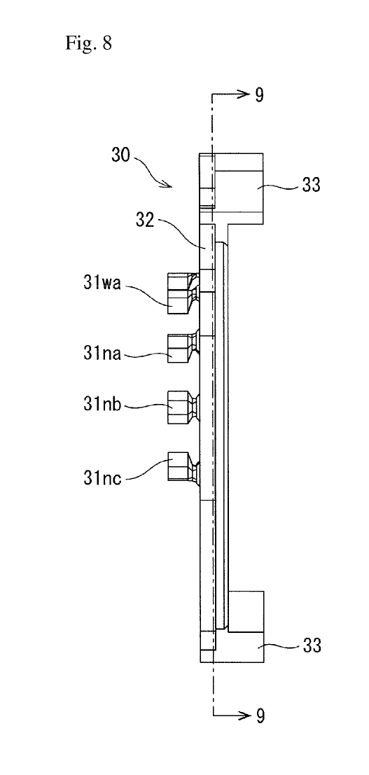

As shown in FIGS. 7 and 8, the surface of the stator frame housing 32 of the stator supporting frame 30, from which the crimp contacts constituting the wire connecting portions 31ua, 31va, 31wa, 31na, 31nb and 31nc project, and the surface of the connector receiving member 10, are both formed on the same flat surface.

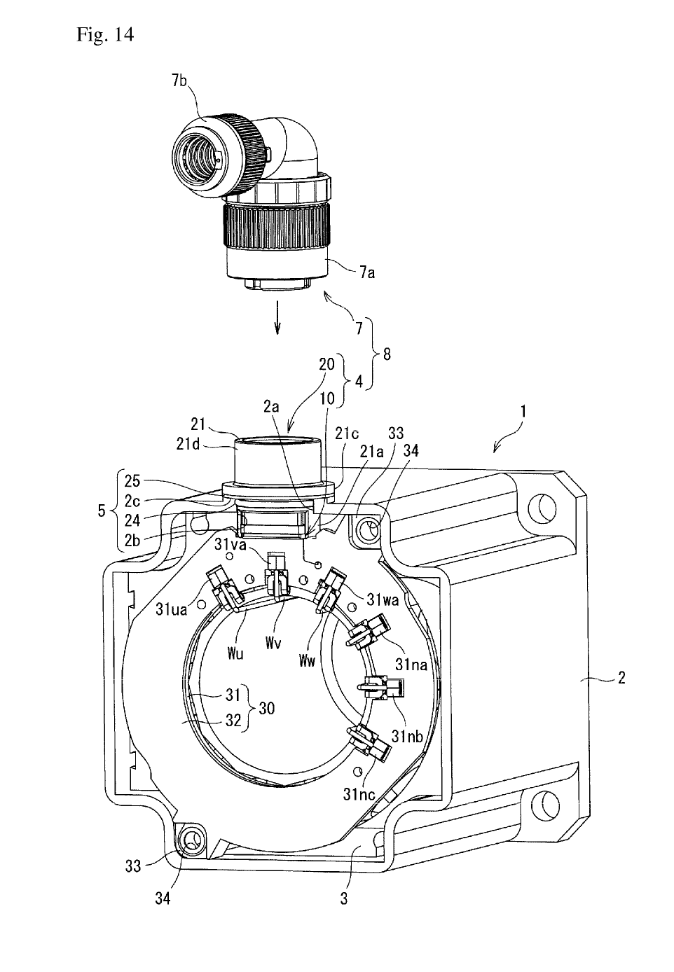

The first connector 20 comprises an insulating connector housing 21 and a plurality of connector contacts 22 mounted to the connector housing 21, as shown in the embodiments of FIGS. 1-6. The connector housing 21 has a substantially cylindrical first mating portion 21a that mates with the connector receiving member 10, and a substantially cylindrical second mating portion 21b that mates with a complementary mating connector 7 to form an external connection to be described below (see FIG. 14). A flange 21c is positioned between the first mating portion 21a and the second mating portion 21b. Each connector contact 22 includes, as shown in the embodiments of FIGS. 6 and 7, a first contact portion 22a, each of which makes contact with each of the grounding contact 12g, the U-phase contact 12u, the V-phase contact 12v, and the W-phase contact 12w of the connector receiving member 10. The first contact portions 22a project into the first mating portion 21a. Each connector contact 22 further includes a second contact portion 22b positioned on an opposite end of connector contact 22 to the first contact portion 22a, that engages with each of the contacts (not shown) of the mating connector 7. The second contact portions 22b project into the second mating portion 21b.

In the embodiments of FIGS. 1-6, an aperture 2a is formed in the motor housing 2 to permit passage of the first mating portion 21a of the first connector 20 upon mating the first connector 20 to the connector receiving member 10.

A seal assembly 5 is positioned between the motor housing 2 and the first mating portion 21a of the first connector 20 when the first connector 20 is mated with the connector receiving member 10, as shown in the embodiments of FIGS. 1 and 6. The seal assembly 5 has a first seal surface 2b formed on the aperture 2a, and an O ring 24 positioned on an outer periphery of the first mating portion 21a of the first connector 20. The O ring 24 contacts the first seal surface 2b and seals a first space between the motor housing 2 and the first mating portion 21a of the first connector 20.

The seal assembly 5 further comprises a second sealing surface 2c formed on an upper surface of the housing 2, and an annular sealing member 25 positioned on a lower surface of the flange 21c. The sealing member 25 abuts the second sealing surface 2c formed on the upper surface of the housing 2 when the first connector 20 is mated with the connector receiving member 10, as shown in the embodiment of FIG. 6. With this positioning, a second space between the lower surface of the flange 21c of the first connector 20 and the second sealing surface 2c of the housing 2 is sealed.

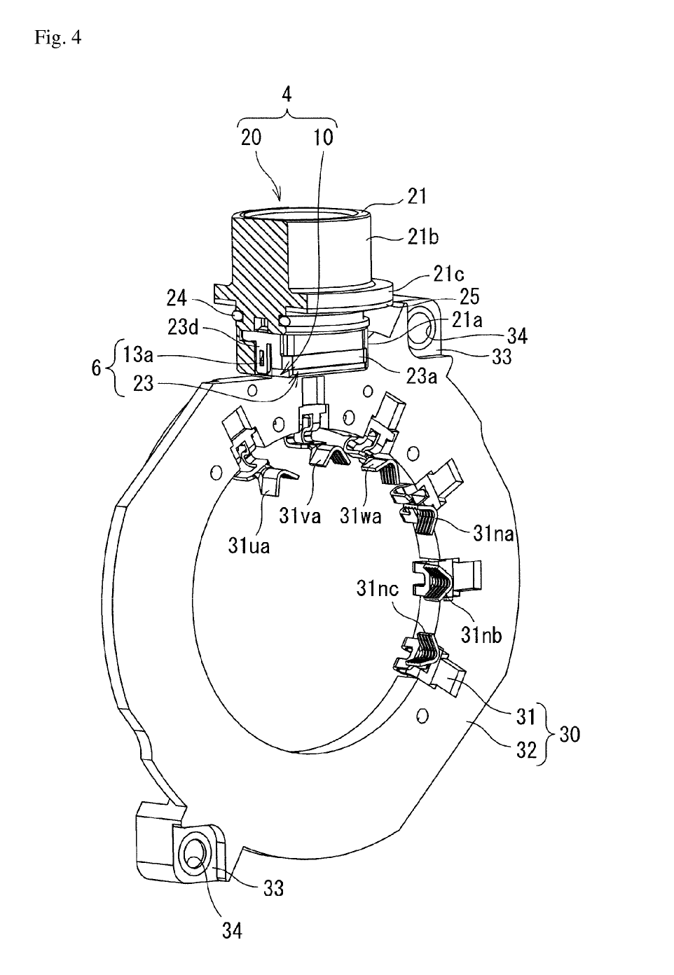

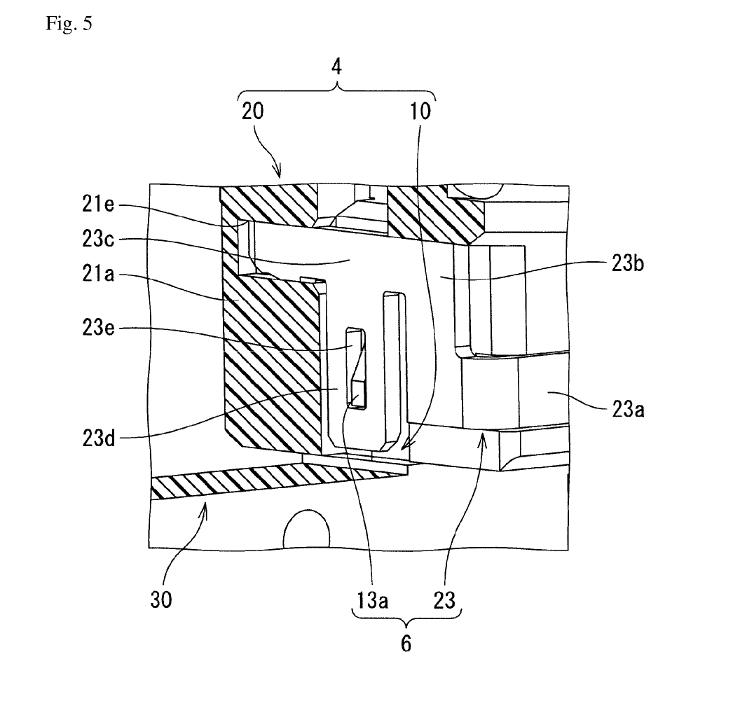

In the embodiments of FIGS. 4 and 5, the connector receiving member 10 and the first connector 20 have a locking mechanism 6 that engages when the first connector 20 is connected to the connector receiving member 10.

The locking mechanism 6 includes protrusions 13a positioned on the connector receiving member 10 and locking members 23 positioned on the first connector 20. The locking members 23 include cantilevered lock arms 23d that engage the protrusions 13a to lock the first connector 20 to the connector receiving member 10. As shown in the embodiment of FIG. 9, the protrusions 13a are formed on metallic members 13, which in turn, are insert molded to the connector mount housing 11. The metallic members 13, including the protrusions 13a, are positioned on opposite sides of the connector mount housing 11 as a pair. The metallic members 13 are insert molded simultaneously with the insert molding of the conductor plate 31.

In the embodiment of FIG. 4, the locking member 23 comprises a base plate 23a extending along a front surface of the first mating portion 21a, perpendicular to the first mating portion 21a. In the embodiment of FIG. 5, a coupling plates 23b are bent substantially perpendicular with respect to the base plate 23a, and are formed on the opposite ends in the lateral direction of the base plate 23a, where only one end in the lateral direction of the base plate 23a is shown in FIG. 5. Anchoring members 23c extend from upper ends of the coupling plate 23b and the elastic lock arms 23d extend downward from lower ends of substantially central portions of the anchoring members 23c. The anchoring members 23c are secured to the first mating portion 21a through press fitting thereto. Each cantilevered lock arm 23d has a protrusion receiving space 23e into which each protrusion 13a is positioned. The locking member 23 is formed by stamping and forming a metallic plate.

In the embodiment of FIG. 5, the locking member 23 is attached to the first mating portion 21a by press-fitting the anchoring members 23c into anchoring member receiving spaces 21e formed in the first mating portion 21a.

Next, assembly steps for mounting the electrical connector 4 to the motor 1 will be described with reference to FIGS. 1 and 10-13.

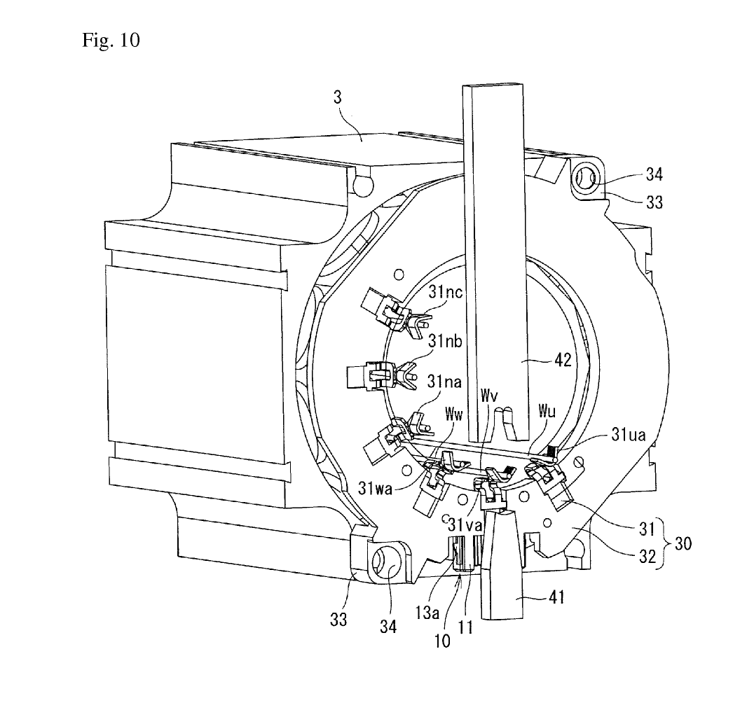

In an embodiment of FIG. 10, the electrical connector 4 is mounted to the motor 1 by first mounting the stator supporting frame 30 to the end surface of the stator 3 by positioning a fastener (not shown) through the fastener receiving through holes 34 of the respective mounting portions 33 of the stator supporting frame 30. In an embodiment, the fasteners are screws.

Next, the wire connecting portion 31ua is crimped to the first end of the U-phase winding Wu and the wire connecting portion 31na to the second end of the U-phase winding Wu using an anvil 41 and a crimper 42. Similarly, the wire connecting portion 31va is crimped to the first end of the V-phase winding Wv and the wire connecting portion 31nb is crimped to the second end of the V-phase winding Wv. The wire connecting portion 31wa is crimped to first end of the W-phase winding Ww and the wire connecting portion 31nc is crimped to the second end of the W-phase winding Ww.

The stator 3 is then positioned in the motor housing 2.

At this point in the assembly, the first connector 20 is separated from the connector receiving member 10. Since the surface of the stator frame housing 32 of the stator supporting frame 30, from which the wire connecting portions 31ua, 31va, 31wa, 31na, 31nb and 31nc project, and the surface of the connector receiving member 10 are formed on the same flat surface, the stator supporting frame 30 and the connector receiving member 10 will not interfere when performing crimping using the anvil 41 and the crimper 42.

Such a structure differs from the conventional connector assemblies, where the first connector 20 is integral with the connector receiving member 10 at the start of the assembly process. In the conventional connector assemblies, the first connector 20 will be in the way and it will be impossible to position the crimp contacts proximate of the anvil 41.

Further, in the conventional connector assemblies, the surface of the stator frame housing 32 from which the crimp contacts project, and the surface of the connector receiving member 10 are not formed on the same flat surface. Consequently, the connector receiving member 10 is in the way, making it impossible to position the crimp contacts proximate of the anvil 41. Otherwise, the stator frame housing 32 will be in the way and operations of the crimper 42 would be hindered.

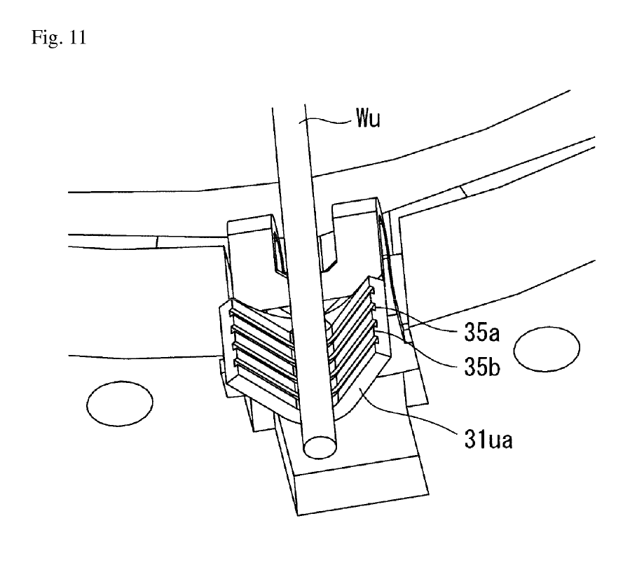

The wire connecting portions 31ua, 31va, 31wa, 31na, 31nb and 31nc each have a plurality of grooves 35a and crimping protrusions 35b that alternately extend orthogonally to the U-phase winding Wu, the V-phase winding Wv and the W-phase winding Ww, as shown in an embodiment of FIG. 11. While the embodiment of FIG. 11 only shows the wire connecting portion 31ua, the remaining wire connection portions 31va, 31wa, 31na, 31nb and 31nc are understood to be substantially the same as the wire connection portion 31ua. The U-phase winding Wu, the V-phase winding Wv, and the W-phase winding Ww are formed of conductive wires. When the wire connecting portions 31ua, 31va, 31wa, 31na, 31nb and 31nc are crimped to the end portions of the U-phase winding Wu, the V-phase winding Wv and the W-phase winding Ww, the crimping protrusions 35b will break through insulated coatings of the conductive wires to contact a conductor core of the wires. Accordingly, by performing crimping operations upon the wire connecting portions 31ua, 31va, 31wa, 31na, 31nb and 31nc of crimp contacts, a separate operation of removing the insulated coatings of conductive wires or performing solder connecting operations are unnecessary, thus permitted automated wire connecting operations.

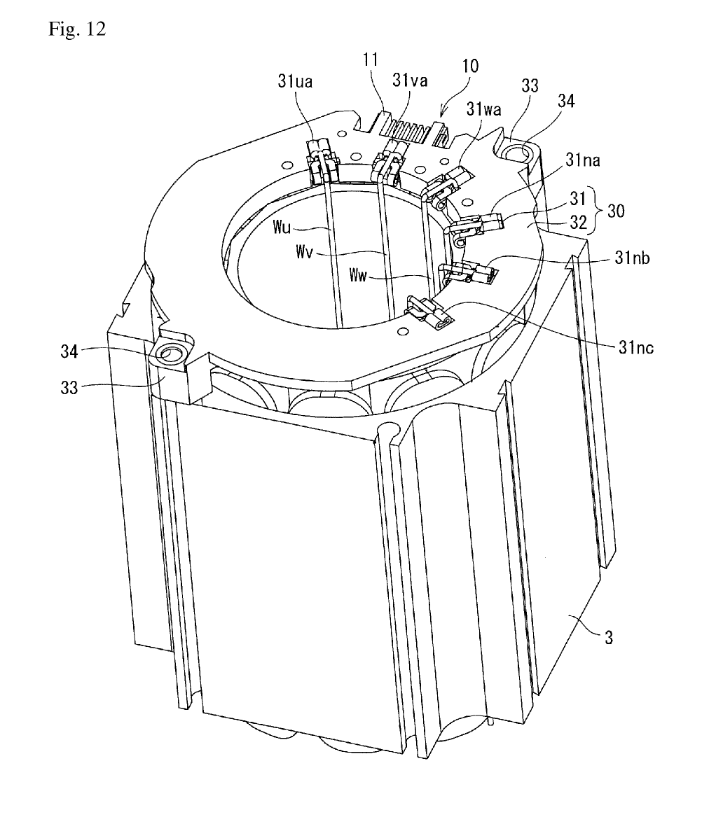

Upon completion of crimping operations of the U-phase winding Wu, the V-phase winding Wv and the W-phase winding Ww, the crimp contacts 31ua, 31va, 31wa, 31na, 31nb and 31nc are folded back to overlap the conductor plate 31, as shown in the embodiment of FIG. 12.

Next, though not shown in the drawings, resin is filled into a space between the motor housing 2 and the connector receiving member 10 to reliably achieve insulation between the grounding contact 12g, the U-phase contact 12u, the V-phase contact 12v and the W-phase contact 12w.

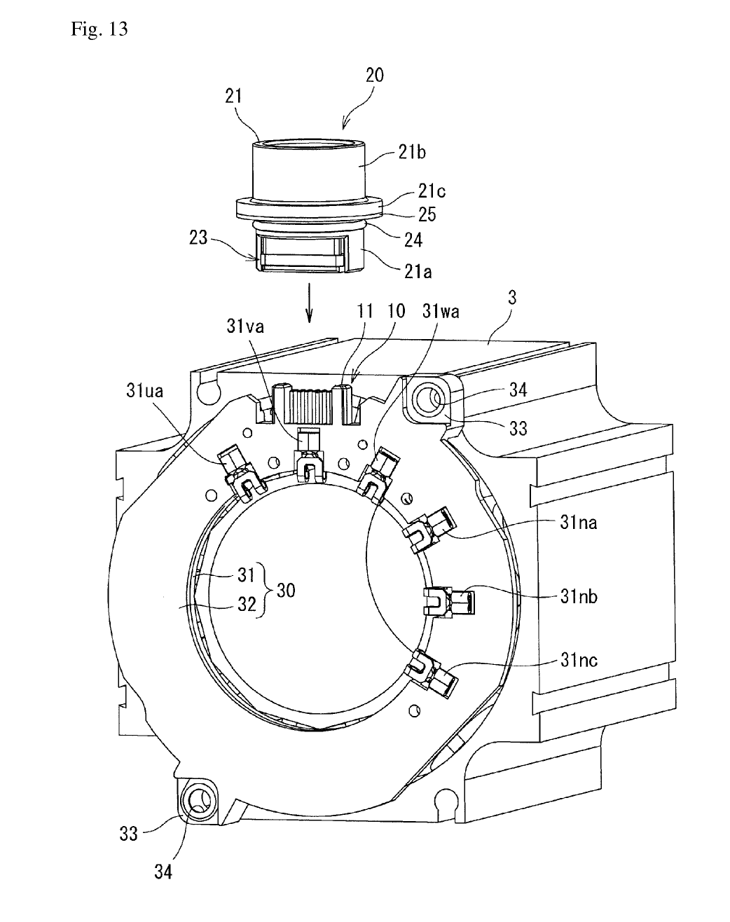

In the embodiment of FIG. 13, the first mating portion 21a of the first connector 20 is mated together with the connector receiving member 10. The electrical connector 4 is then mounted with the motor 1, as shown in the embodiment of FIG. 1.

When the first mating portion 21a of the first connector 20 is mated with the connector receiving member 10, the connector contacts 22 of the first connector 20 contact the grounding contact 12g, the U-phase contact 12u, the V-phase contact 12v and the W-phase contact 12w of the connector receiving member 10. With this arrangement, the first connector 20 will be electrically connected to the connector receiving member 10.

When the first mating portion 21a of the first connector 20 is mated with the connector receiving member 10, the elastic lock arms 23d will be elastically displaced outward by the protrusions 13a, as shown in the embodiments of FIGS. 4 and 5. Upon completion of the mating, the protrusions 13a are positioned in the protrusion receiving spaces 23e and the elastic lock arms 23d elastically return to their original position. With this arrangement, the first connector 20 and the connector receiving member 10 are locked together. Detachment of the first connector 20 from the connector receiving member 10 is therefore preventable without requiring the use of additional elements, such as fasteners, etc. In this respect, since the elastic lock arms 23d engage the protrusions 13a, the first connector 20 is held securely to the connector receiving member 10.

During mating of the first mating portion 21a of the first connector 20 with the connector receiving member 10, the first mating portion 21a is received through the aperture 2a formed on the housing 2 to mate with the connector receiving member 10. The O ring 24 on the first connector 20 contacts the first sealing surface 2b of the housing 2 to seal the space between the housing 2 and the first mating portion 21a. With this arrangement, a reliable seal is created in the space between the motor housing 2 and the first mating portion 21a of the first connector 20. Moreover, since the O ring 24 is used as the seal assembly 5 at the first connector 20, the sealing function is achieved through a simple configuration.

When the first mating portion 21a is mated with the connector receiving member 10, the sealing member 25 positioned on the lower surface of the flange 21c of the first connector 20 abuts the second sealing surface 2c formed on the upper surface of the housing 2, as shown in the embodiment of FIG. 6. Therefore, a seal is formed in the space between the lower surface of the flange 21c and the second sealing surface 2c. Accordingly, the space between the motor housing 2 and the flange 21c is reliably sealed.

The mating connector 7 is then mated with the first connector 20 of the electrical connector 4, as shown in the embodiment of FIG. 14. The mating connector 7 comprises a connector mating portion 7a that mates with the second mating portion 21b of the first connector 20, and a cable connecting portion 7b, to which a power supply cable (not shown) is connected.

Since the mating connector 7 is connected to the power supply through the power supply cable, and to the first connector 20, power is supplied to the motor 1 side.

A motor connector assembly 8, which includes the electrical connector 4 and the mating connector 7, is mated with the first connector 20 of the electrical connector 4.

While embodiments of the present invention have been described above, the present invention is not limited to these, and one of ordinary skill in the art would recognize that various changes and improvements may be made without departure from the spirit and scope of the invention.

For example, while the seal assembly 5 seals the space between the motor housing 2 and the first connector 20, one of ordinary skill in the art would appreciate that the seal assembly 5 may include more or less components than the first sealing surface 2b, the O ring 24, the second sealing surface 2c or the sealing member 25.

Further the locking mechanism 6 may optionally be used, or in some embodiments, absent or positioned on other members of the electrical connector 4.

Additionally, the surface of the connector receiving member 10 may be positioned on a different surface of the stator supporting frame 30, or may project from the surface of the stator frame housing 32 but, for example, be recessed. Further, the stator supporting frame 30 might be mounted to the housing 2 instead of the stator 3.

What is claimed is:

1. A electrical connector for a motor comprising:
a connector receiving member disposed on an outer peripheral portion of a stator supporting frame, the stator supporting frame being connected to a stator or a motor housing;
a first connector having a first mating portion that mates with the connector receiving member; and
a seal assembly positioned in a space between the motor housing and the first mating portion.

2. The electrical connector of claim 1, wherein the stator supporting frame comprises:
a conductor plate having wire connecting portions connected to first and second ends of stator windings; and
an insulating stator frame housing positioned over the conductor plate to cover the conductor plate except for the wire connecting portions, the stator frame housing being attached to the stator.

3. The electrical connector of claim 2, wherein the conductor plate includes a grounding plate portion, a U-phase portion, a V-phase portion, a W-phase portion, or a neutral grounding portion.

4. The electrical connector of claim 2, wherein a surface of the connector receiving member and a surface of the stator supporting frame from which the wire connecting portions project are the same surface.

5. The electrical connector of claim 1, wherein the seal assembly comprises:
a first sealing surface formed on the motor housing, and
an O ring positioned on an outer peripheral surface of the first connector, and in contact with the sealing surface.

6. The electrical connector of claim 1, further comprising a complementary locking mechanism positioned on the connector receiving member and the first connector.

7. The electrical connector of claim 6, wherein the locking mechanism includes a locking member positioned on the first connector.

8. The electrical connector of claim 7, wherein the locking member includes cantilevered lock arms having a protrusion receiving space.

9. The electrical connector of claim 8, wherein the locking mechanism further includes protrusions positioned on the connector receiving member and insertable into the protrusion receiving space.

10. The electrical connector of claim 2, wherein the wire connecting portions are crimp contacts projecting from a first surface of the conductor plate.

11. The electrical connector of claim 10, wherein a surface of the connector receiving member extends in approximately the same plane as the first surface of the conductor plate.

12. An electrical connector assembly comprising:
a motor-mounted electrical connector having;
a connector receiving member disposed on an outer peripheral portion of a stator supporting frame, the stator supporting frame being connected to a stator or a motor housing,
a first connector having a first mating portion that mates with the connector receiving member, and
a seal assembly positioned in a space between the motor housing and the first mating portion, and
a complementary mating connector mated to the first connector.
